(19) United States
(12) Patent Application Publication
(10) Pub. No.: US 2007/0221134 A1
(43) Pub. Date: Sep. 27, 2007

(54) AUTOMATIC FILTRATION APPARATUS

(75) Inventors: Yuan-Nan CHU, TAIPEI CITY (TW); Nai-Hsien Chao Liao, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: FISHERIES RESEARCH INSTITUTE, KEELUNG CITY (TW)

(21) Appl. No.: 11/679,471

(22) Filed: Feb. 27, 2007

(30) Foreign Application Priority Data
Feb. 27, 2006 (TW) 095203322

(51) Int. Cl. A01K 63/04

(52) U.S. Cl. 119/259

(57) ABSTRACT

An automatic filtration apparatus is disclosed. The apparatus is comprised of a tank, a filtration body, a motor, a spray device and a control unit. The filtration body is disposed upon the tank to accommodate chemical solution(s) and aquatic organism(s) or aquatic organism with undesirable debris. The surface of the filtration body has a filtering cloth for preventing the organisms from being passed through the filtering cloth. The filtration body can be replaceable according to the volume of the organisms. The motor is used to drive the filtration body to implement swinging motion. The spray device can be disposed at two sides of the filtration body. The spray device is used for spraying water to rinse the organisms off the upper portion of the filter. The control unit controls the swinging motion of the filtration body and the spray action based on predetermined parameters.

### FIELD OF THE INVENTION

The present invention relates to an automatic filtration apparatus, and more particularly to the automatic filtration apparatus that is suitable for manipulating live or aquatic organisms.

### BACKGROUND OF THE INVENTION

As the artificial propagation technique of live/aquatic organisms has been gradually developed into maturation, demands for the commercial scale production of live/aquatic organisms are also increasing accordingly. The chromosome manipulation technique has been applied mostly to the shellfish propagation, such as for small abalones, abalones or oysters, to produce low-cholesterol infertile shellfishes. In the artificial propagation technique, rinsing unfertilized or fertilized eggs of the aquatic organisms is a routing work which requires much labor and time in many commercial operations. The artificial propagation procedure also involves adding chemicals to the eggs and temperatures control during the operations. Besides rinsing the foregoing eggs of the live/aquatic organisms, the manipulation technique could be further applied to produce health foods, not only improving the revenues of the aquaculture farmers, but also providing more options for consumers who desire something other than the natural shellfishes. However, the traditional rinsing work and chromosome manipulation technique rely on labor powers and may not be accurately carried out due to human errors. While using the conventional hand net to rinse and filter unfertilized or fertilized eggs, or aquatic organisms, the eggs and the organisms are usually accumulated on the bottom of the hand net resulting in non-uniform distribution. The user also needs to wear gloves throughout the manipulation to reduce the risk of exposure to chemicals which attach to the eggs since the chemicals would penetrate cell membrane easily. The filtering cloth of the hand net are easily clogged by the eggs or small aquatic organisms, reducing the speed of filtration, increasing the chemical residue on the eggs, thereby requiring more time and effort to process the eggs. There are many variables on manual manipulation that is unable to be controlled effectively. Consequently, the accuracy of the chromosome manipulation is reduced.

To deal with the foregoing shortcomings, the inventor(s) based on years of experience on related research and development of the automatic aquaculture device have invented an automatic filtration apparatus in hope of overcoming the foregoing problems.

### SUMMARY OF THE INVENTION

An object of the present invention is to provide an automatic filtration apparatus to enhance the efficiency of filtration manipulation for live or aquatic organisms.

To achieve the aforesaid object, the automatic filtration apparatus includes a tank, a filtration body, a motor, a spray device and a control unit. The filtration body is disposed upon the tank to accommodate chemical solution(s) and aquatic organisms which may contain undesirable debris. The tank can contain water or other fluids. The surface of the filtration body has a filtering cloth for preventing the organisms from being passed through the filtering cloth. The filtration body is replaceable according to the volume of the organisms to be treated. The motor is used to drive the filtration body to perform swinging motions. The spray device consists of a number of spray nozzles which are installed on sides of the filtration body. The spray device can spray water to clear the organisms off the upper portion of the filter while rinsing chemicals from the surface of the eggs or the organisms to stop the chemical reaction on time. The control unit can control the swinging motion of the filtration body and the spray action based on predetermined parameters. Moreover, the filtration body further has an upward opening to help the eggs and the organisms to be easily put in or taken out.

The automatic filtration apparatus has the following characteristics:

The filtration body rotates back and forth allowing more rapid filtration and better survival rate of the live/aquatic organisms. The efficiency of rinsing the chemical solutions from the organisms is further enhanced by adding the spray device. By lowering and raising the tank, the filtration body and the aquatic organisms there-within can be removed from or submerged into the chemical containing liquid rapidly, thereby increasing the precision of treatment time. The tank may contain a water jacket so that the temperature of the liquid within the filtration body is maintained in the optimum range for the particular organisms being treated. The operating temperature, process time, and other operating parameters may be stored in and called from the control unit conveniently. The control unit can be equipped with a touch screen monitor for easy programming and automatic operation. Using the automatic filtration apparatus, the entire artificial manipulation steps could be carried out by one person, saving both time and labor. Experiment results have shown that the yield rate and the quality of the products both are improved over manual operations using the conventional hand net.

Other features and advantages of the present invention and variations thereof will become apparent from the following description, drawings, and claims.

### BRIEF DESCRIPTION OF THE DRAWINGS

FIG. 1 is a perspective diagram illustrating an automatic filtration apparatus according to an embodiment of the invention; and

FIG. 2 is a cross-sectional view illustrating an automatic filtration apparatus according to an embodiment of the invention.

### DETAILED DESCRIPTION OF THE PREFERRED EMBODIMENTS

Referring to the related figures for the automatic filtration apparatus according to a preferred embodiment of the present invention, wherein the same elements are described by the same reference numerals.

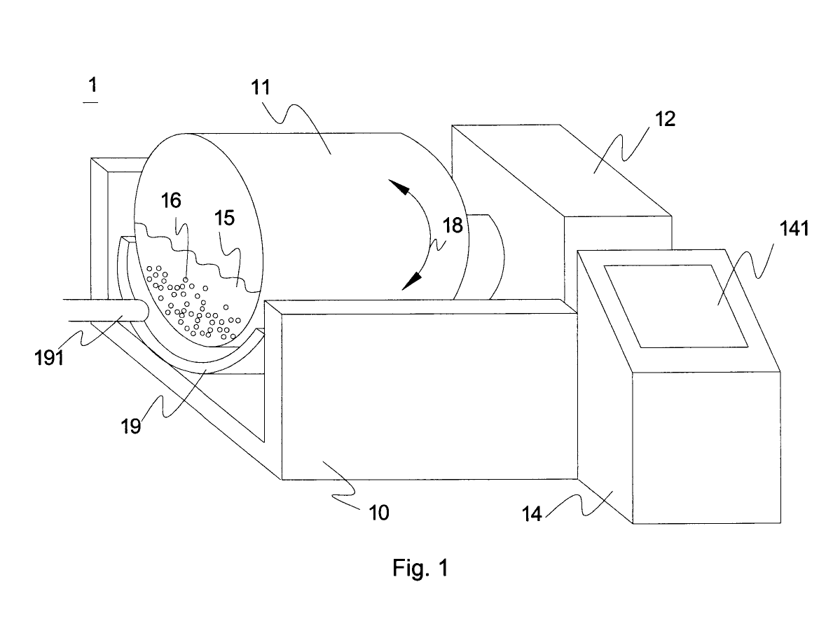

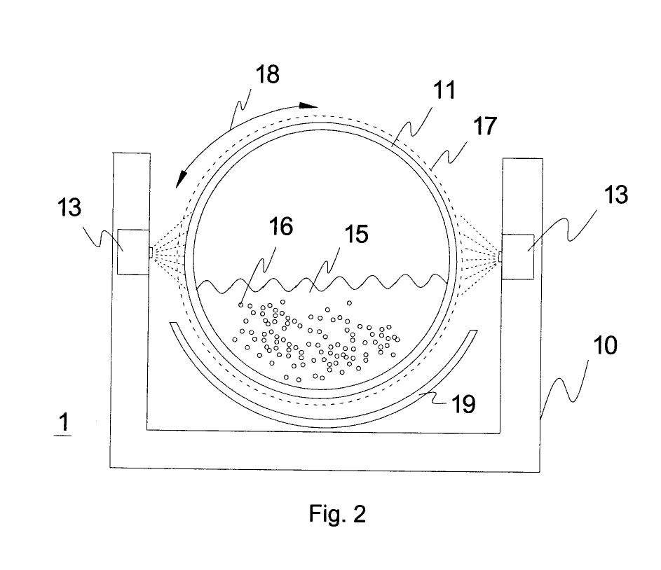

The principle of the invention is to reduce human errors through the apparatus so as to simultaneously perform large-scale induction with fewer labors. Further, the fertilized eggs or the organisms will not be physically damaged to achieve the reproducibility of triploidy. Referring to FIG. 1 and FIG. 2, an automatic filtration apparatus 1 includes a tank 10, a filtration body 11, a motor 12, a spray device 13 (as shown in FIG. 2), and a control unit 14. The filtration body 11 is disposed upon the tank 10 to accommodate a chemical solution 15 and organisms 16 which may contain undesirable debris. The tank 10 can contain water, such as sea water, fresh water or other fluids. The surface of the filtration body 11 has a filtering cloth 17 (shown in FIG. 2) for preventing the organisms 16 from being passed through the filtering cloth 17. The filtration body 11 is replaceable according to the volume of the organisms 16 to be treated. The motor 12 is used to drive the filtration body 11 to rotate back and forth 18 to increase the filter area. The filter area then is adequately utilized to filter undesirable debris or the chemical solution 15 from the filtration body 11 through a centrifugal force. The tank 10 can be lowered and raised to help the filtration body 11 and the organisms 16 there-within to be removed from or submerged into the chemical containing liquid rapidly, so as to increase the precision of treatment time. Because the organisms are unable to pass through the filtering cloth 17, the chemical solution 15 can be rinsed from the organisms 16. However, if the filtering cloth 17 is clogged by the organisms 16, the filtration efficiency will be influenced. Considering the above-mentioned situation, the spray device 13 is added and consists of a number of spray nozzles (not shown) which are installed on two sides of the filtration body 11. The spray device 13 is designed for spray water to clear the organisms 16 off the upper portion of the filtering cloth 17. The organisms 16 can be appropriately concentrated on the bottom to efficiently enhance filtration or dipping process, thereby achieving the goal of saving chemicals. The control unit 14 controls the swinging motion of the filtration body 11 and spraying action based on predetermined parameters.

Moreover, the tank 10 further includes a water jacket 19 which can be disposed under the filtration body 11 and mounted on the tank 10. The water jacket 19 can fill water with a predetermined temperature for the organisms through an intake-water pipe 191. The filtration body 11 can be a rotating drum corresponding to the water jacket 19. The water jacket 19 can also be raised and lowered together with the tank 10 through the control of the control unit 14 to submerge the organisms within the filtration body 11, thereby providing optimum temperatures for the artificial manipulation. Furthermore, the automatic filtration apparatus 1 also includes a transparent casing (not shown in the figure) for covering the apparatus 1 so that the temperature of the water within the filtration body could be maintained in the optimum range for the particular organisms being treated and prevents the organisms from being interfered by the outside, thereby eliminating errors during the operations. Two sensors (not shown in the figure) can be added and disposed at the side of the tank 10 to sense liquid level and temperatures.

The automatic filtration apparatus 1 is adapted to manipulate different organisms. For instance, if aquatic organisms are hyperthermophiles, the manipulation process can proceed at appropriate temperatures by injecting water of predetermined temperatures into the water jacket 19 to simulate the optimal environment where the hyperthermophiles can process their optimal reaction and normal development. The efficiency of manipulation and convenience is therefore guaranteed.

The organism can be aquatic juveniles or spawned-eggs. The spawned-eggs include eggs of brine shrimp (Artemia), oyster, abalone or other aquatic species. The filtering cloth 17 disposed onto the filtration body 11 is plankton net. The filtration body 11 can be equipped with the filtering cloth 17 with different mesh sizes to meet different organisms. Water within the tank 10 could be expelled through a water pump (not shown in the figure). The control unit 14 can be a programmable logic controller or a fuzzy logic controller. The control unit 14 is further equipped with a display 141 for showing a user interface to input predetermined parameters and show the status such as angles, drum speeds, pump flows, durations or other conditions. The display 141 could be a touch screen monitor. The control unit 14 also has buttons for turning on/off or performing other functions of the automatic filtration apparatus 1. The swinging motion of the filtration body 11 (rotating drum) can be adjusted by the following predetermined parameters, including rotation speeds, pump flows, swinging angles, temperature setting, time setting, rinsing frequencies and other parameters. The predetermined parameters can be stored in the control unit 14 as a file. While manipulating the apparatus 1 next time, the file will be directly called out to increase the efficiency of manipulation for respective target.

In addition, the automatic filtration apparatus 1 does not only limit to the chromosome manipulation for fertilized eggs of shellfishes or finfishes, but also includes the field work of rinsing solutions from the aquatic organisms. For instance, when the shelled brine shrimp eggs or post-hatching juveniles of finfishes and shellfishes are treated with medicament treatments, the automatic filtration apparatus 1 can be efficiently utilized to remove solution, seawater or freshwater from the eggs or the juveniles.

To drive the filtration body 11, a shaft (not shown in the figure) can be added and penetrates through the filtration body 11 to support the swinging motion. The shaft can be movably assembled to pivots rotably mounted on a frame of the apparatus 1. One of the pivots can be pivotally coupled to a lever arm. The level arm can have two ribs for buckling a bolt movably fastened to at least one aperture on an adjustment disc. It should be noted that the aperture can be plural numbers, not restricted to only one. The apertures could be uniformly disposed to the surface of the adjustment disc, and used to adjust the swinging angles of the filtration body 11. Namely, if the bolt is positioned to different apertures, the shaft will be driven by the pivots and the level arm to enable the filtration body 11 to achieve the rotation with 360 degrees, allowing faster filtration and better survival rate of the organisms.

The filtration body 11 can be made by acrylic material. When the filtering cloth 17 is spread to the filtration body 11, at least one fastening member, such as a white iron plate, can be utilized to fasten the filtering cloth 17. Two sides of the fastening member can be folded to attach two surfaces of the filtration body 11, and have through holes. Two lock members such as screws can employed to drill the surfaces of the filtration body 11 to lock the fastening member by passing through the through holes, so as to accordingly fasten the filtering cloth 17. The mesh size of the filtering cloth 17 can be 70 μm, which prevents the small eggs from being drawn into the filtration body 11. Moreover, two nylon ropes are utilized to widen the filtering cloth 17 without generating crinkles. Therefore, the filtration process will not be influenced. The size of the filtration body can be diversity upon demands.

The apparatus 1 would ensure that egg quality is not compromised in the process. The procedures that would be automatically manipulated include the transfer of eggs from egg fertilization, treatment with chemicals such as cytochalasin B (CB), egg rinsing and concentrating. Several of these procedures, such as egg rinsing and concentrating, have to be repeated several times during mass propagation and chromosome manipulation. Other procedures, such as chemical treatment, require accurate timing to start and stop.

The automatic filtration apparatus can be operated for mass propagation in small abalone. The propagation procedure could be done by a user at the push of a button disposed to the automatic filtration apparatus, and illustrated in detail as below:

Firstly, eggs and sea water are prepared in large quantity, and an intake-material electromagnetic value is used to control the transfer of the eggs to concentrate sea water and the eggs to the tank. Afterward, sea water is expelled through the water pump to remain eggs and sea water in small quality, so as to add sperm for fertilizing with eggs. Fertilization starting with timer setting is performed, and then fresh sea water is infused into the tank. Those eggs then are rinsed to complete the procedure. Lastly, the water pump is used again to expel sea water after the experiment is done.

Furthermore, the procedure for chromosome manipulation of small abalone can be programmed using the programmable logic controller of the apparatus 1, and illustrated in more detail. Eggs and sea water are prepared in large quantity, and an intake-material electromagnetic value is used to control the transfer of the eggs to concentrate sea water and the eggs to the tank. Afterward, sea water is expelled through the water pump to remain eggs and sea water in small quality, so as to add sperm for fertilizing with eggs. Fertilization starting with timer setting is performed, and then fresh sea water is infused into the tank. Those eggs then are rinsed and the water pump is used again to expel sea water, thereby remaining fertilized eggs in sea water. CB (cytochalasin B) is added to prevent actin filaments of eggs from assembling. Triploid induction with PLC (programmable logic control) timer setting then is performed. Fresh sea water is infused again into the tank and eggs are rinsed to remove CB. Sea water and CB then are expelled through the water pump to remain fertilized eggs in sea water. DMSO (dimethyl sulfoxide) then is added in order to perform removal of CB with PLC timer setting. Fresh sea water is infused into the tank again and eggs then are rinsed. Lastly, sea water and DMSO then are expelled through the water pump to remain fertilized eggs in sea water, thereby finishing the entire procedure.

Although the features and advantages of the embodiments according to the preferred invention are disclosed, it is not limited to the embodiments described above, but encompasses any and all modifications and changes within the spirit and scope of the following claims.

What is claimed is:

1. An automatic filtration apparatus comprising:
a tank;
a filtration body disposed upon said tank for accommodating at least one chemical solution and organisms or aquatic organisms with undesirable debris, and a surface of said filtration body having a filtering cloth for preventing said organisms from being passed through said filtering cloth, wherein said filtering cloth and said filtration body are replaceable according to the volume of said organisms;
a motor for driving said filtration body to implement a swinging motion;
a spray device installed at two sides of said filtration body, and for spraying water to clear said organisms off said filtering cloth; and
a control unit for controlling said swinging motion of said filtration body based on predetermined parameters.

2. The automatic filtration apparatus of claim 1, wherein said automatic filtration apparatus further includes a water jacket, and a fluid with predetermined temperature flows in said water jacket that provides a specific temperature condition for said organisms or said aquatic organisms.

3. The automatic filtration apparatus of claim 2, wherein said water jacket is arc shape.

4. The automatic filtration apparatus of claim 2, wherein said water jacket is elevated to submerge said organisms or said aquatic organisms within said filtration body to provide optimum temperatures for manipulation.

5. The automatic filtration apparatus of claim 1, wherein said filtration body is a rotating drum.

6. The automatic filtration apparatus of claim 1, wherein said organisms are aquatic juveniles or spawned-eggs.

7. The automatic filtration apparatus of claim 6, wherein said spawned-eggs include eggs of brine shrimp (Artemia), oyster, abalone or other aquatic species.

8. The automatic filtration apparatus of claim 1, wherein said swinging motion of the filtration body is adjusted by said predetermined parameters of rotation speeds, pump flows, swinging angles, temperature setting, time setting, rinsing frequencies and other parameters.

9. The automatic filtration apparatus of claim 1, wherein said chemical solution is fresh water, seawater or solution for chromosome manipulation.

10. The automatic filtration apparatus of claim 1, wherein said automatic filtration apparatus further includes a display for showing a user interface, thereby inputting said predetermined parameters.

11. The automatic filtration apparatus of claim 1, wherein said filtration body is equipped with a filtering cloth with different mesh sizes to meet different organisms.
